(19) United States
(12) Patent Application Publication
(10) Pub. No.: US 2019/0205041 A1
(43) Pub. Date: Jul. 4, 2019

(54) DISC DRIVE THROUGHPUT BALANCING

(71) Applicant: Seagate Technology LLC, Cupertino, CA (US)

(72) Inventors: Jiangnan Lin, Singapore (SG); Xiong Liu, Singapore (SG); WenXiang Xie, Singapore (SG)

(21) Appl. No.: 15/858,130

(22) Filed: Dec. 29, 2017

(51) Int. Cl. G06F 3/06; G06F 12/02; G11B 20/18; G11B 20/12

(52) U.S. Cl. CPC G06F 3/0617; G06F 12/0223; G06F 3/0632; G06F 3/0644; G06F 3/0689; G11B 20/1889; G11B 2020/1242; G06F 2212/1032; G06F 2212/152; G06F 2212/21; G06F 2212/262; G06F 2212/70; G11B 20/1217

(57) ABSTRACT

Implementations disclosed herein provide an apparatus including a storage media and a storage controller configured to divide physical storage space of the storage media into a plurality of media zones between an inner diameter (ID) and an outer diameter (OD) of the storage media, and write LBA sectors to the media zones in a direction from the ID to the OD and writing the data in the direction from the OD to the ID within each media zone.

### BACKGROUND

Storage disks are frequently used to store digital data. For example, a user may store digital photographs, digital songs, or digital videos on a computer disk drive that includes one or more storage disks. As digital content becomes increasingly popular, consumer demand for storage capacity may correspondingly increase. The storage capacity of a disk may be limited by formatting of the disk. During formatting, a storage disk is scanned for defects and is divided into smaller units of storage based on detected defects. Improved formatting techniques may improve the storage capacity of storage disks.

### SUMMARY

Implementations disclosed herein provide an apparatus including a storage media and a storage controller configured to divide physical storage space of the storage media into a plurality of media zones between an inner diameter (ID) and an outer diameter (OD) of the storage media, and write LBA sectors to the media zones in a direction from the ID to the OD and writing the data in the direction from the OD to the ID within each media zone.

In an alternative implementation, a method disclosed herein includes dividing physical storage space of a storage media into a plurality of media zones, wherein the plurality of media zones are aligned between an inner diameter (ID) and an outer diameter (OD) of the storage media; and dividing the logical block address (LBA) space mapped to the storage area into a plurality of LBA sectors, writing the LBA sectors to the media zones in a direction from the ID to the OD, and within each media zone, writing the data in the direction from the OD to the ID.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. These and various other features and advantages will be apparent from a reading of the following Detailed Description.

### BRIEF DESCRIPTIONS OF THE DRAWINGS

A further understanding of the nature and advantages of the present technology may be realized by reference to the figures, which are described in the remaining portion of the specification.

FIG. 1 illustrates an example data storage device including a transducer head assembly for writing data on a magnetic storage medium.

FIG. 2 illustrates example logical block address (LBA) mapping for a conventional media recording (CMR) data storage device disclosed herein.

FIG. 3 illustrates another example LBA mapping for the CMR data storage device disclosed herein.

FIG. 4 illustrates yet another example LBA mapping for a shingled media recording (SMR) data storage device disclosed herein.

FIG. 5 illustrates yet another example LBA mapping for the SMR data storage device disclosed herein.

FIG. 6 illustrates an example schematic for the data transfer scheme of the data storage device disclosed herein.

FIG. 7 illustrates an example flowchart implementing the data transfer scheme disclosed herein for a CMR HDD.

FIG. 8 illustrates an example flowchart implementing the data transfer scheme disclosed herein for an SMR HDD.

FIG. 9 illustrates an example processing system that may be useful in implementing the technology described herein.

### DETAILED DESCRIPTION

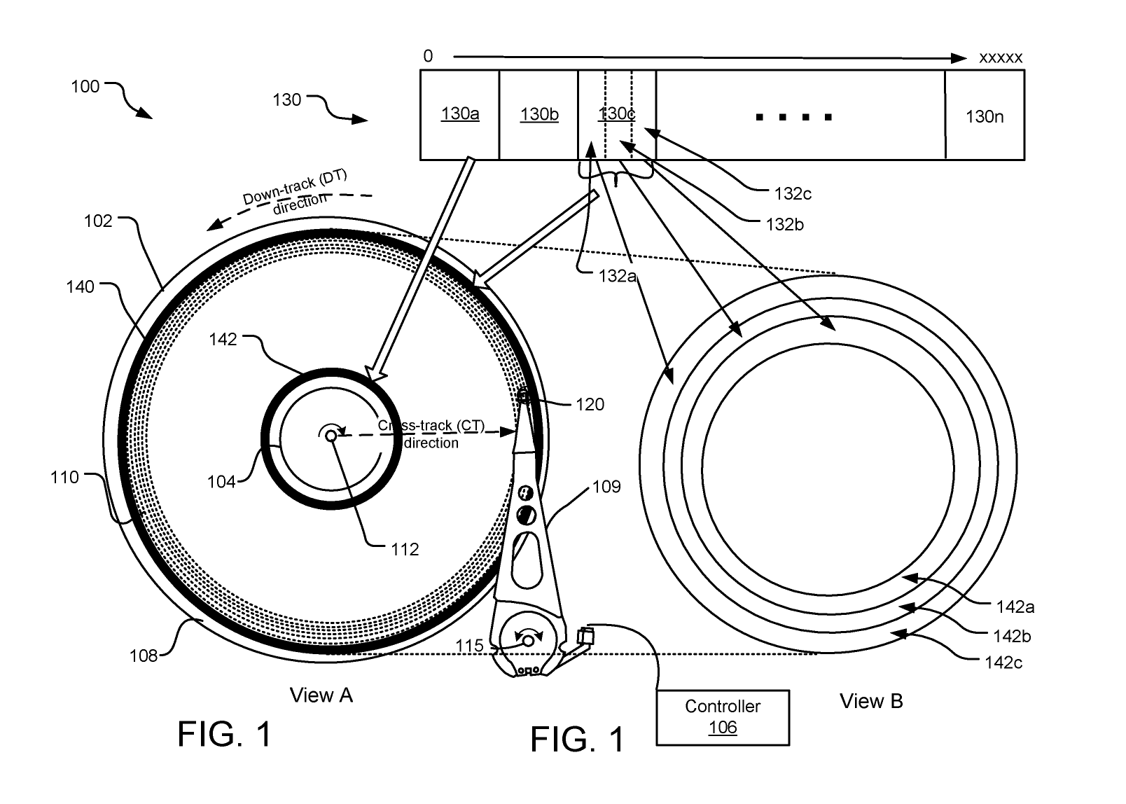

FIG. 1 illustrates a data storage device 100 including a transducer head assembly 120 for writing data on a magnetic storage medium 108. Although other implementations are contemplated, the magnetic storage medium 108 is, in FIG. 1, a magnetic storage disc on which data bits can be recorded using a magnetic write pole (not shown) and from which data bits can be read using a magnetoresistive element (not shown). The magnetic write pole and the magnetoresistive element may be implemented on the transducer head assembly 120. As illustrated in View A, the storage medium 108 rotates about a spindle center or a disc axis of rotation 112 during rotation, and includes an inner diameter (ID) 104 and an outer diameter (OD) 102 between which are a number of concentric data tracks 110. Information may be written to and read from data bit locations in the data tracks 110 on the storage medium 108.

The transducer head assembly 120 is mounted on an actuator assembly 109 at an end distal to an actuator axis of rotation 112 where the actuator assembly 109 may swivel around an actuator axis 115. The transducer head assembly 120 flies in close proximity above the surface of the storage medium 108 during disc rotation. The actuator assembly 109 rotates during a seek operation about the actuator axis of rotation 112. The seek operation positions the transducer head assembly 120 over a target data track for read and write operations.

As the data tracks closer to the OD 102 have longer arc length, they store more data than the data tracks near the ID 104. Therefore, as the transducer head assembly 120 reads data from the OD 102 to the ID 104, the throughput (usually provided as Megabytes/Second (MB/s)) of the storage device drops. The low throughput near the ID 104 may limit the use of the storage device 100 in some applications, such as for storing surveillance data. In an implantation of the storage device 100, the data tracks of the storage medium 108 are divided into a number of media zones from the OD 102 to the ID 104. For example, two such media zones of the storage medium 108 as shown in FIG. 1 include an outer media zone 140 and an inner media zone 142.

For a hard disc drive (HDD) the throughput drops from the OD to ID. The lower throughput at the ID limits the use of the HDD in certain applications, such as surveillance. In an implementation of a redundant arrays of independent/inexpensive discs (RAID) system, alternate drives are implemented to seek in opposite direction. For example, in one implementation, odd drives may be implemented to have forward seek from OD to ID whereas even drives are implemented to have reverse seek from ID to OD. However, due to HDD's misalignment of the start data sectors, reserves seek on the even drives may cause the drive to miss the next starting point of the next track after finishing of writing or reading on a given track. This results in a missed revolution for the even drives that are implemented to use reverse seek. An implementation disclosed herein modifies the reverse seek on the even drives to have hybrid seeking where the writable space of the HDD is divided into zones and while reverse seek is implemented across the zones, within each zone, forward seek is implemented. Various implementations of such hybrid seek are disclosed below in FIGS. 1-7.

The storage device 100 also includes a controller 106 that manages various operations of the storage device 100. The controller 106 includes software and/or hardware, and may be implemented in any tangible computer-readable storage media within or communicatively coupled to the storage device 100. The term “tangible computer-readable storage media” includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information and which can accessed by a mobile device, a computer 20, etc. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal.

When the storage device 100 is implemented using hybrid seek disclosed herein, the physical storage space of the storage media 108 may be identified by physical block addresses (PBAs). In one implementation, the PBAs may start from the OD 102 and increase towards the ID 104. FIG. 1 also illustrates a range of logical block addresses (LBAs) 130 (also referred to as the LBA space 130) that provides a logical mapping of data stored on the storage device 100. In many storage devices, the LBAs 130 are mapped to consecutive and contiguous data tracks of the storage media 108. For example, the LBAs 130 may be numbered from 0 to xxxxx as shown in FIG. 1 with LBA₀ mapped to a PBA₀, LBA₁ mapped to PBA₁, LBAₙ mapped to PBAₙ, etc.

The LBA space 130 may be used by a host (not shown) communicatively connected to the storage device 100 to specify one or more commands to the storage device 100. For example, the host may specify writing data to LB_{A} to LBAₙ₊ₓ. The controller 106 may receive and analyze this command and determine the PBAs where the data is to be written.

In an implementation of the storage device 100, the storage controller 106 is configured to divide the LBA space 130 into a number of LBA sectors 130ₐ, 130_{b}, . . . 130_{g}. The storage controller 106 may map the LBA sectors 130ₐ, 130_{b}, . . . 130ₙ to the media zones 140, 142, etc. In one implementation, the storage controller 106 maps the LBA sectors 130ₐ, 130_{b}, . . . 130ₙ to the media zones 140, 142 from the ID to the OD. Thus, for example, an LBA sector near the beginning of the LBA space 130 (e.g., towards LBA address 0) is mapped to a PBA that is closer to an ID 104 whereas an LBA sector whereas an LBA sector near the end of the LBA space 130 (e.g., towards LBA address xxxxx) is mapped to a PBA that is closer to the OD 102. As an example, FIG. 1 shows that the LBA sector 130ₐ is mapped to the media zone 142, whereas the LBA sector 130_{c} is mapped to a media zone 140.

Furthermore, within each media zone, the storage controller 106 maps the LBA addresses from the OD to the ID. Thus, for example, for the media zone 142, which is also shown in View B, the direction of mapping the LBA to the PBA is from the OD 102 to the ID 104. The LBA sector 130_{c} (which is mapped to the media zone 142) is illustrated as divided in three LBA sub-sectors 132a, 132b, 132c and the media zone 142 is divided into three media tracks 142a, 142b, 142c. In one implementation, the LBA sub-sector 132a is mapped to the media track 142c, the LBA sub-sector 132b is mapped to the media track 142b, and the LBA sub-sector 132c is mapped to the media track 142a. Thus, within a given media zone, an LBA sub-sector with a lower LBA address is mapped to a media track closer to the OD 102, whereas an LBA sub-sector with a higher LBA address is mapped to a media track closer to the ID 104.

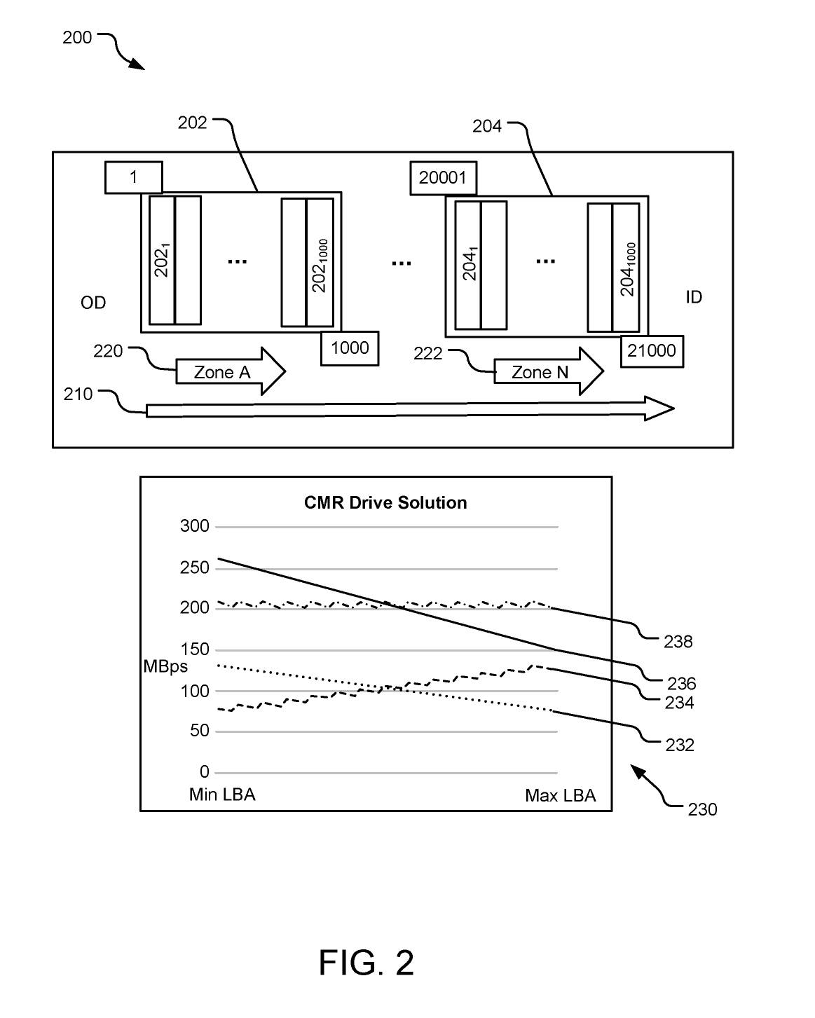

FIG. 2 illustrates logical block address (LBA) mapping 200 for the data storage device to implement a conventional seeking method. For example, the LBA map 200 may be implemented on odd drives of a RAID array. Specifically, FIG. 2 illustrates the LBA mapping 200 that employs the combination of forward and reverse seek in a conventional magnetic recording (CMR) drive. The LBA map 200 is divided into a number of zones such as zone A 202, . . . Zone N 204. The controller (such as the controller 106 of FIG. 1) maps the zones across the disc drive in a forward seek mode wherein the drives stores the LBAs from OD toward ID. That is, Zone A 202 is mapped closer to the OD whereas the zone n 204 is mapped to the ID. This is further illustrated by the seek direction 210. As illustrated the LBA map 200 has low address LBAs (e.g., 1-1000) closer to the OD and higher address LBAs (e.g., 20001-21000) closer to the ID. The performance of the storage device implementing the seeking method disclosed in FIG. 2 is illustrated by the graph 232.

Furthermore, each zone 202, 204 comprises a number of tracks combined to form the particular zone. For example, the zone A 202 is divided into tracks 202₁ to 202₁₀₀₀, The zone 204 is divided into 204₂₁₀₀₁ to 204₂₁₀₀₀, etc. The controller is configured to map the zones within each track in a forward seek mode as denoted by the directions 220, 222. Thus, the tracks 202, to 202₁₀₀₀ are mapped in the direction of OD to ID, the tracks 204₁ to 204₁₀₀₀ are mapped in the direction of OD to ID, etc.

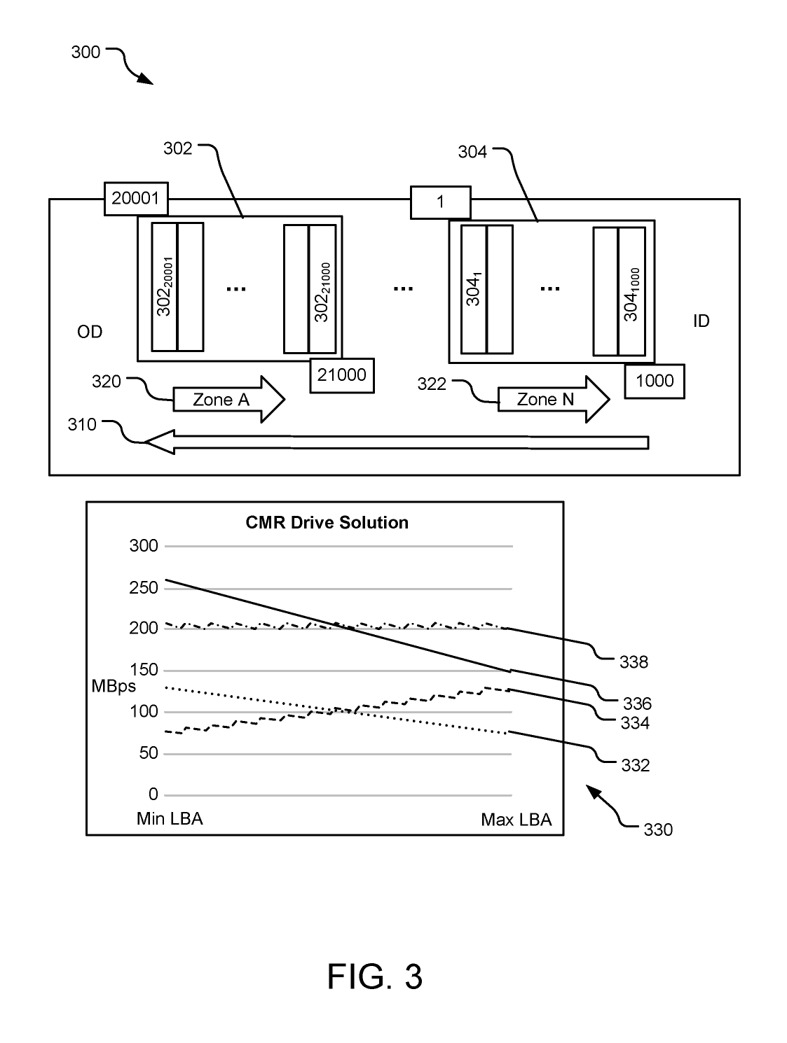

FIG. 2 also illustrates graphs 230 illustrating the throughput (MB/s) in the CMR seek solution as disclosed by the LBA map 200. Specifically, graph 232 discloses the throughput of an odd drive that in a RAID. Specifically, this odd drive may be implemented to have a forward seek from OD to ID. Graph 234 discloses the throughput of an even drive that is implemented to use hybrid seek as disclosed by 300 in FIG. 3. The combined throughput of a RAID where an odd drive has forward seek and an even drive has a hybrid seek (reverse seek across the zones of the drive and forward seek across the tracks within zones) is disclosed by graph 238, which is combination of the throughput 232 of the odd drive with forward seek and the throughput 234 of the even drive with hybrid seek. As shown, the combined throughput 238 is substantially uniform across the LBA range from minimum LBA to the maximum LBA. Compared to that the throughput of a RAID that does not implement forward and reverse seek is disclosed by the graph 236, which decreases substantially towards the maximum LBA end of the LBA range.

FIG. 3 illustrates logical block address (LBA) mapping 300 for the data storage device disclosed herein to implement a hybrid seek. For example, the LBA map 300 may be implemented on even drives of a RAID array. Specifically, FIG. 3 illustrates the LBA mapping 300 that employs the combination of forward and reverse seek in a conventional magnetic recording (CMR) drive. The LBA map 300 is divided into a number of zones such as zone A 302, . . . Zone N 304. The controller (such as the controller 106 of FIG. 1) maps the zones across the disc drive in a reverse seek mode. That is, Zone A 302 is mapped closer to the OD whereas the zone n 304 is mapped to the ID. This is further illustrated by the seek direction 310. As illustrated the LBA map 300 has high address LBAs (e.g., 20001-21000) closer to the OD and higher address LBAs (e.g., 1-1000) closer to the ID.

Furthermore, each zone 302, 304 is divided into a number of tracks. For example, the zone A 302 is divided into tracks 302₂₀₀₀₁ to 302₂₁₀₀₀, The track 304 is divided into subzones 304₁ to 304₁₀₀₀, etc. The controller is configured to map the zones within each subzone in a forward seek mode as denoted by the directions 320, 322. Thus, the tracks 302₂₀₀₀₁ to 302₂₁₀₀₀ are mapped in the direction of OD to ID, the tracks 304₁ to 304₁₀₀₀ are mapped in the direction of OD to ID, etc.

FIG. 3 also illustrates graphs 330 illustrating the throughput (MB/s) in the CMR seek solution as disclosed by the LBA map 300. Specifically, graph 332 discloses the throughput of an odd drive that in a RAID. Specifically, this odd drive may be implemented to have a forward seek from OD to ID. Graph 334 discloses the throughput of an even drive that is implemented to use hybrid seek as disclosed herein. The combined throughput of a RAID where an odd drive has forward-seek and an even drive has a hybrid-seek (reverse seek across the zones of the drive and forward seek across the tracks within zones) is disclosed by graph 338, which is combination of the throughput 332 of the odd drive with forward-seek and the throughput 334 of the even drive with hybrid-seek. As shown, the combined throughput 338 is substantially uniform across the LBA range from minimum LBA to the maximum LBA. Compared to that the throughput of a RAID that does not implement forward and reverse seek is disclosed by the graph 336, which decreases substantially towards the maximum LBA end of the LBA range.

HDDs using shingled media recording (SMR), data is grouped into isolated storage bands/data zones. Each of the storage bands contains a group of shingled tracks located in the main store of the drive. SMR allows for increased areal density capability (ADC) as compared to conventional magnetic recording (CMR) but at the cost of some performance ability. Specifically, writing data on the SMR drive has to follow the direction of the shingling in each data zones or storage bands. In an SMR drive, in the OD zones shingle direction is from OD to ID and the OD zones store data from lower LBAs. On the other hand, in the ID zones the shingle direction is from ID to OD and the ID zones store larger LBA. As a result, reverse LBA writing in SMR drives may significantly slow down the wiring performance.

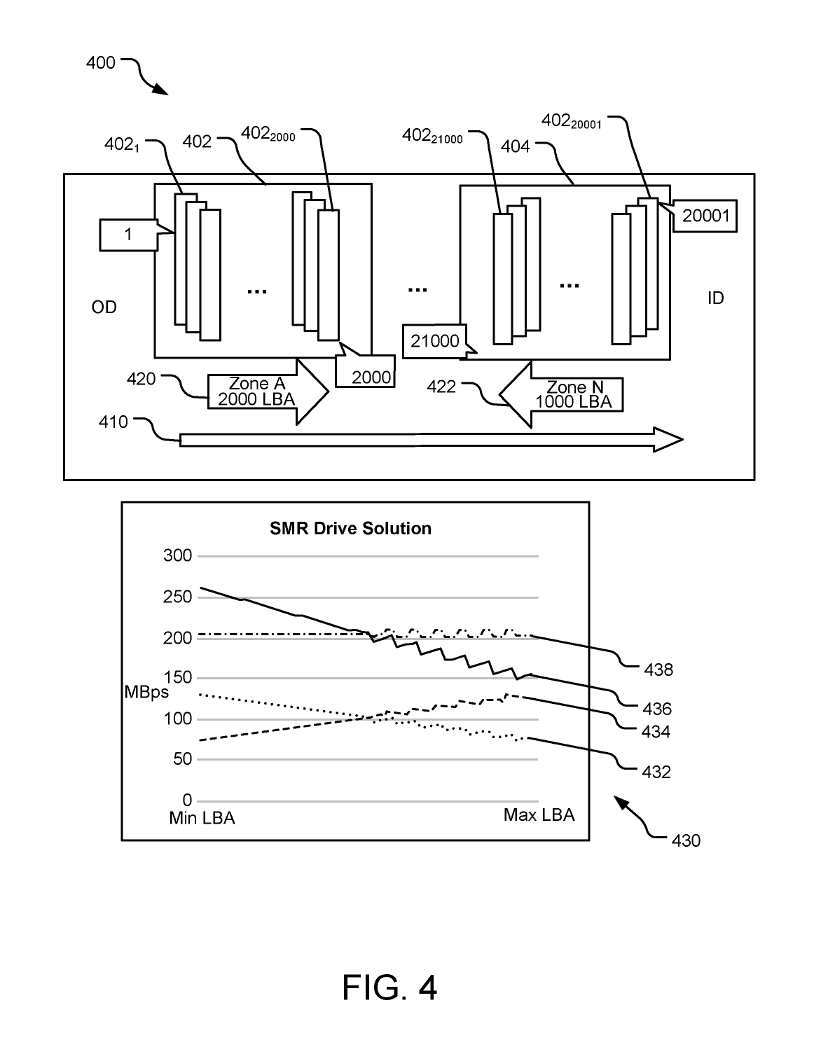

FIG. 4 illustrates yet another LBA mapping 400 for an SMR data storage device disclosed herein. For example, the LBA map 400 may be implemented on odd drives of a RAID array. Specifically, FIG. 4 illustrates the LBA mapping 400 that employs the forward seek in an SMR drive. The LBA map 400 is divided into a number of zones such as zone A 402, . . . Zone N 404. The controller (such as the controller 106 of FIG. 1) maps the zones across the disc drive in a forward-seek mode. That is, Zone A 402 is mapped closer to the OD whereas the zone n 404 is mapped to the ID. This is further illustrated by the seek direction 410. As illustrated the LBA map 400 has low address LBAs (e.g., 1-2000) closer to the OD and higher address LBAs (e.g., 20001-21000) closer to the ID.

Furthermore, each zone 402, 404 may be include a number of SMR bands and may be divided into a number of tracks. For example, the zone A 402 is divided into SMR bands/tracks 402₁ to 402₁₀₀₀, the track 404 is divided into subzones 404₂₀₀₀₁ to 404₂₁₀₀₀, etc. The controller is configured to map the zones within each subzone in an SMR reverse-seek mode as denoted by the direction 420 for the zones near OD. On the other hand, the controller is configured to map the zones within each subzone in an SMR forward-seek mode as denoted by the direction 422 for the zones near ID. Thus, the tracks 402₁ to 402₁₀₀₀ are mapped in the direction of OD to ID, the tracks 404₂₀₀₀₁ to 404₂₁₀₀₀ are mapped in the direction of ID to OD, etc.

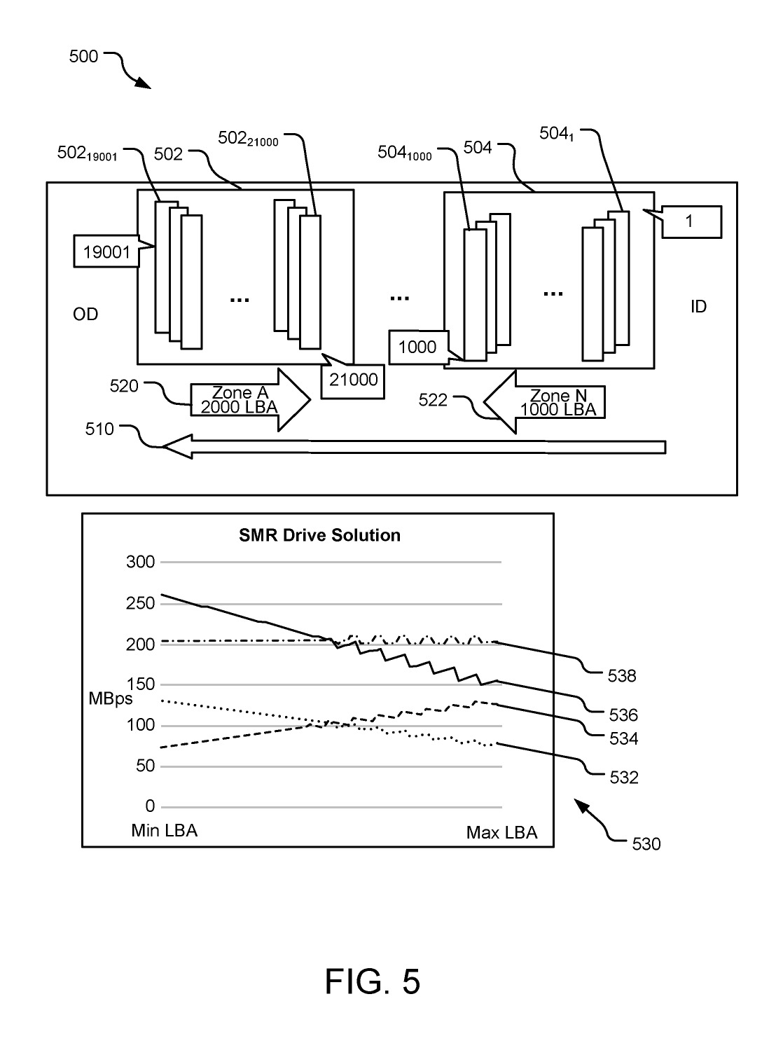

FIG. 4 also illustrates graphs 430 illustrating the throughput (MB/s) in the SMR seek solution as disclosed by the LBA map 400. Specifically, graph 432 discloses the throughput of an odd SMR drive that in a RAID. Specifically, this odd drive may be implemented to have an SMR forward seek from OD to ID. Graph 434 discloses the throughput of an even SMR drive that is implemented to use hybrid-seek as disclosed by 500 in FIG. 5. The combined throughput of a RAID where an odd drive has forward-seek and an even drive has a hybrid-seek (reverse-seek across the zones of the drive, forward-seek across the tracks within zones near the OD, and reverse-seek across the tracks within zones near the ID) is disclosed by graph 438, which is combination of the throughput 432 of the odd drive with forward-seek and the throughput 434 of the even drive with hybrid-seek. As shown, the combined throughput 438 is substantially uniform across the LBA range from minimum LBA to the maximum LBA. Compared to that the throughput of a RAID using SMR drives that does not implement forward and reverse seek is disclosed by the graph 436, which decreases substantially towards the maximum LBA end of the LBA range.

FIG. 5 illustrates yet another LBA mapping 500 for the SMR data storage device disclosed herein. For example, the LBA map 500 may be implemented on even SMR drives of a RAID array. Specifically, FIG. 5 illustrates the LBA mapping 500 that employs the combination of forward and reverse seek in an SMR drive. The LBA map 500 is divided into a number of zones such as zone A 502, . . . Zone N 504. The controller (such as the controller 106 of FIG. 1) maps the zones across the disc drive in a reverse-seek mode. That is, Zone A 502 is mapped closer to the OD whereas the zone n 504 is mapped to the ID. This is further illustrated by the seek direction 510. As illustrated the LBA map 500 has low address LBAs (e.g., 1-1000) closer to the ID and higher address LBAs (e.g., 19001-21000) closer to the OD.

Furthermore, each zone 502, 504 may have a number of SMR bands and may be divided into a number of tracks. For example, the zone A 502 is divided into SMR bands/tracks 502₁₉₀₀₁ to 502₂₁₀₀₀, the track 504 is divided into SMR bands/subzones 504₁ to 504₁₀₀₀, etc. The controller is configured to map the zones within each subzone in an SMR forward-seek mode as denoted by the direction 520 for the zones near OD. On the other hand, the controller is configured to map the zones within each subzone in an SMR reverse-seek mode as denoted by the direction 522 for the zones near ID. Thus, the tracks 502₁₉₀₀₁ to 502₂₁₀₀₀ are mapped in the direction of OD to ID, the tracks 404₁ to 404₁₀₀₀ are mapped in the direction of ID to OD, etc.

FIG. 5 also illustrates graphs 530 illustrating the throughput (MB/s) in the SMR seek solution as disclosed by the LBA map 500. Specifically, graph 532 discloses the throughput of an odd SMR drive that in a RAID. Specifically, this odd drive may be implemented to have an SMR forward seek from OD to ID. Graph 534 discloses the throughput of an even SMR drive that is implemented to use hybrid-seek as disclosed herein. The combined throughput of a RAID where an odd drive has forward-seek and an even drive has a hybrid-seek (reverse-seek across the zones of the drive, forward-seek across the tracks within zones near the OD, and reverse-seek across the tracks within zones near the ID) is disclosed by graph 538, which is combination of the throughput 432 of the odd drive with forward-seek and the throughput 534 of the even drive with hybrid-seek. As shown, the combined throughput 538 is substantially uniform across the LBA range from minimum LBA to the maximum LBA. Compared to that the throughput of a RAID using SMR drives that does not implement forward and reverse seek is disclosed by the graph 536, which decreases substantially towards the maximum LBA end of the LBA range.

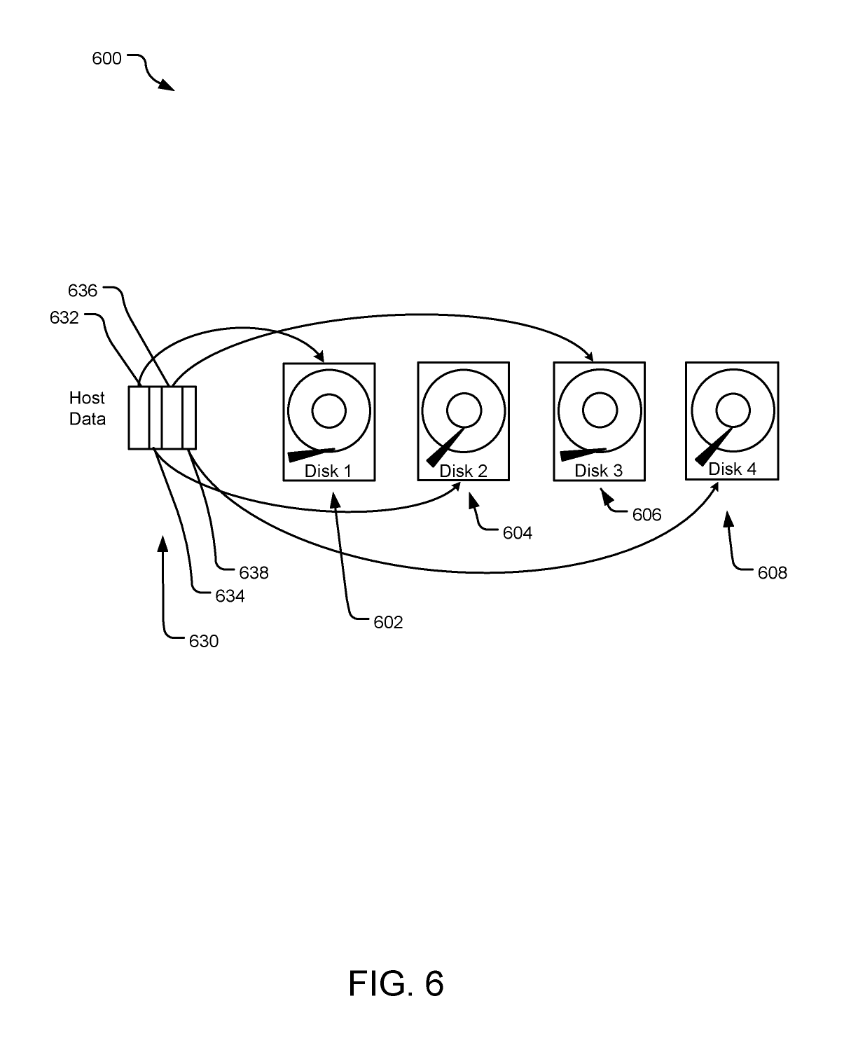

FIG. 6 illustrates a schematic 600 for the data transfer scheme of the data storage device disclosed herein. For example, the controller of the storage device, such as a RAID array, maps various sections 632-638 of the host data 630 to various disks 602-608 based on the throughput of the drives. Thus, if the disk 608 has lower throughput, smaller sectors of the host data—denoted by the section 638 is distributed to the disk 4 608. On the other hand, if disk 3 606 has a higher throughput, a larger section of the host data 630 such as the section 636 is distributed to the disk 3 606.

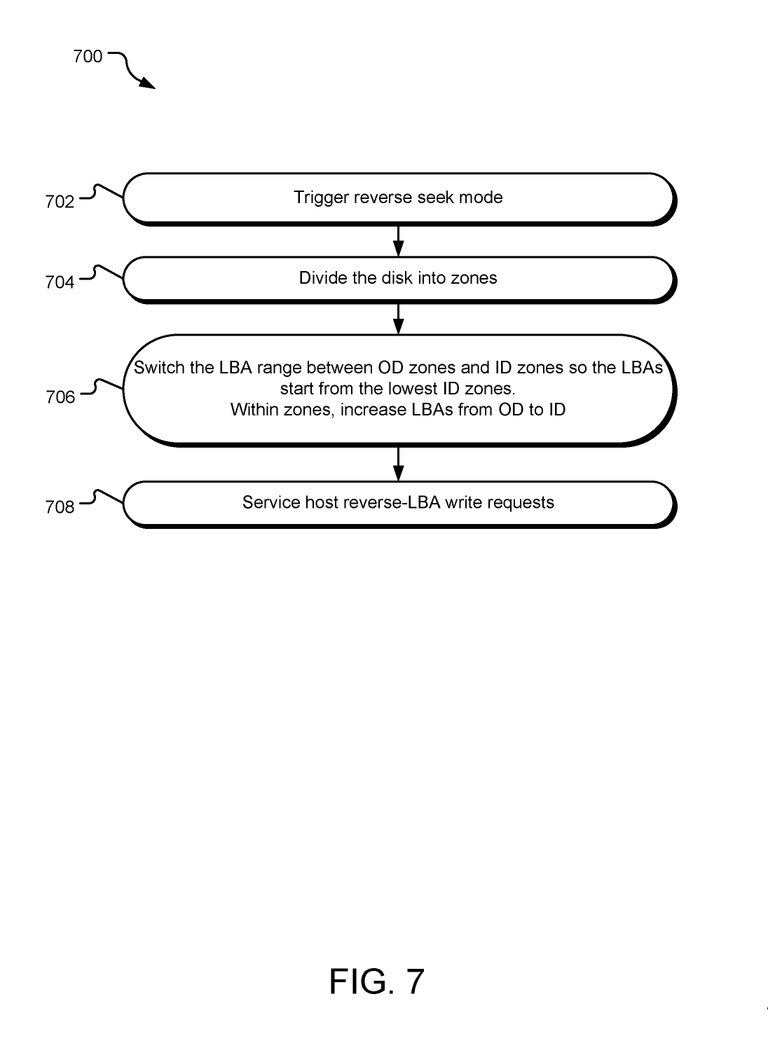

FIG. 7 illustrates a flowchart 700 implementing the data transfer scheme disclosed herein for a CMR HDD. An operation 702 triggers a reverse-seek mode in an HDD by a host during a RAID0 initialization. An operation 704 divides the disc LBA space into several zones. An operation 706 switches the LBA range between OD zones and ID zones so the LBAs start from the lowest ID zones. Within zones, the operation 706 increases LBAs from OD to ID. An operation 708 initiates servicing the reverse LBA write requests from the host.

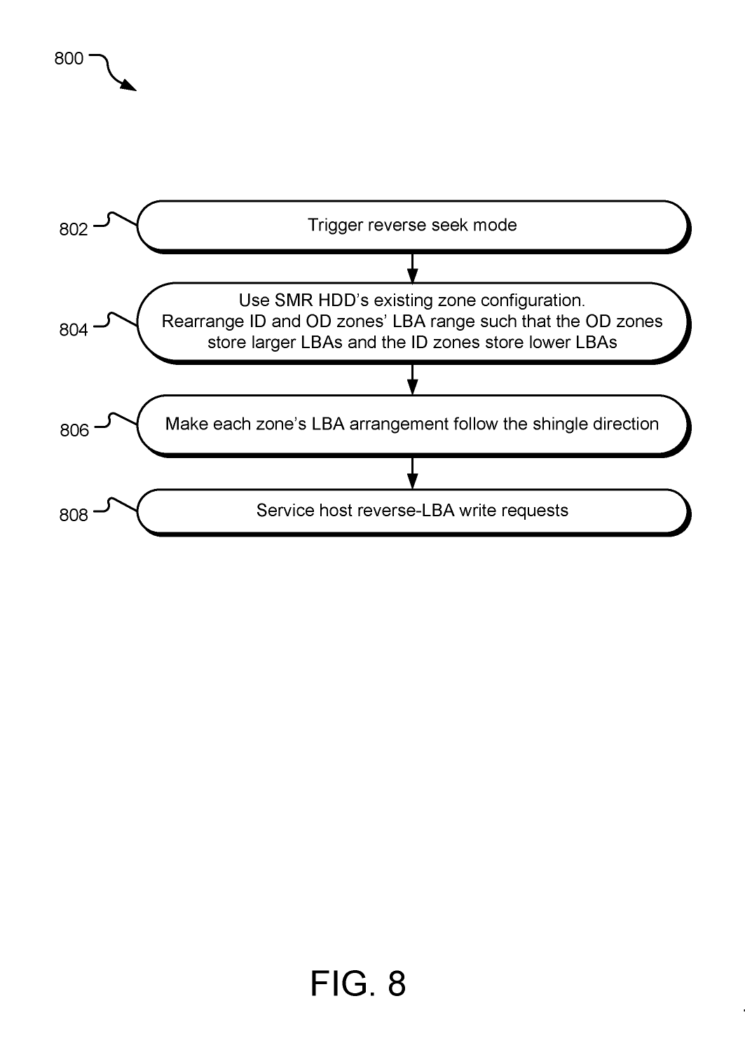

FIG. 8 illustrates a flowchart 800 implementing the data transfer scheme disclosed herein for an SMR HDD. An operation 802 triggers a reverse-seek mode in an HDD by a host during a RAID0 initialization. An operation 804 uses SMR HDD's existing zone configuration and rearrange ID and OD zones' LBA range such that the OD zones store larger LBAs and the ID zones store lower LBAs. An operation 806 makes each zone's LBA arrangement follow the shingle direction. An operation 808 initiates servicing the reverse LBA write requests from the host.

The throughput balancing scheme disclosed herein allows HDDs to increase minimum throughput of the RAID system. Specifically, for HDDs using CMR, the throughput balancing scheme disclosed herein reduces the reverse-seek time. For HDDs using SMR, the throughput balancing scheme disclosed herein increases the SMR drive's ability to write with reverse LBA direction, even with dynamic writing. Furthermore, the throughput balancing scheme disclosed herein allows HDDs to be set into reverse-seek mode during RAID0 initialization.

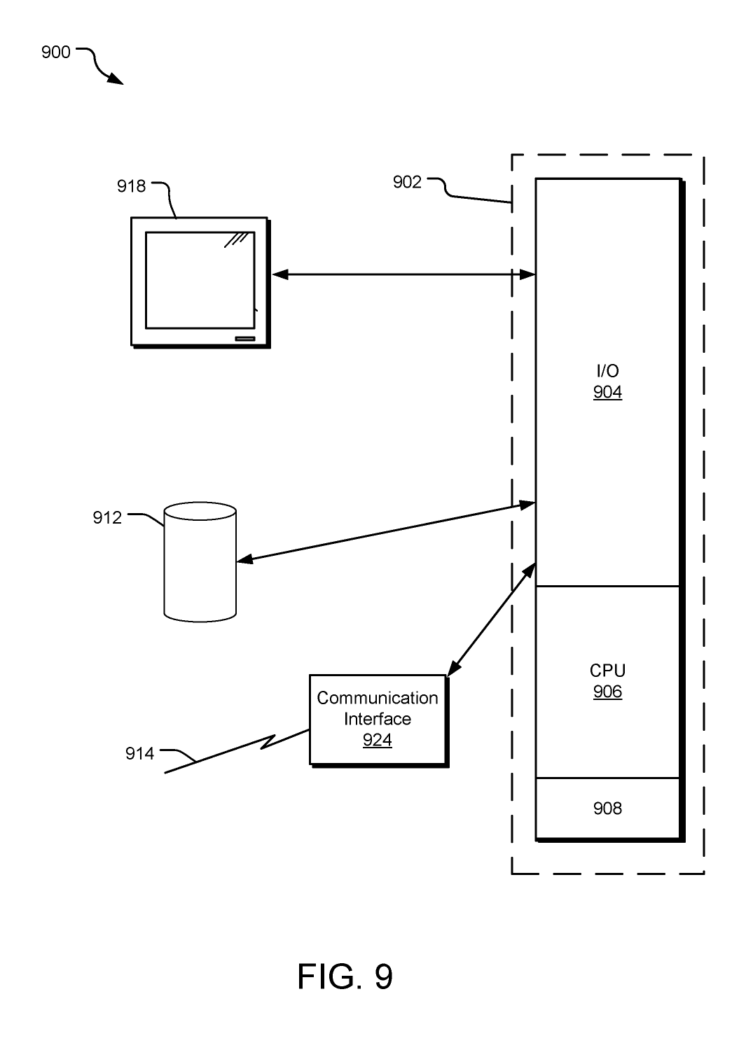

FIG. 9 illustrates an example processing system 900 that may be useful in implementing the described technology. The processing system 900 is capable of executing a computer program product embodied in a tangible computer-readable storage medium to execute a computer process. Data and program files may be input to the processing system 900, which reads the files and executes the programs therein using one or more processors (e.g., CPUs, GPUs, ASICs). Some of the elements of a processing system 900 are shown in FIG. 9 wherein a processor 902 is shown having an input/output (I/O) section 904, a Central Processing Unit (CPU) 906, and a memory section 908. There may be one or more processors 902, such that the processor 902 of the processing system 900 comprises a single central-processing unit 906, or a plurality of processing units. The processors may be single core or multi-core processors. The processing system 900 may be a conventional computer, a distributed computer, or any other type of computer. The described technology is optionally implemented in software loaded in memory 908, a storage unit 912, and/or communicated via a wired or wireless network link 914 on a carrier signal (e.g., Ethernet, 3G wireless, 5G wireless, LTE (Long Term Evolution)) thereby transforming the processing system 900 in FIG. 9 to a special purpose machine for implementing the described operations. The processing system 900 may be an application specific processing system configured for supporting the disc drive throughput balancing system disclosed herein.

The I/O section 904 may be connected to one or more user-interface devices (e.g., a keyboard, a touch-screen display unit 918, etc.) or a storage unit 912. Computer program products containing mechanisms to effectuate the systems and methods in accordance with the described technology may reside in the memory section 908 or on the storage unit 912 of such a system 900.

A communication interface 924 is capable of connecting the processing system 900 to an enterprise network via the network link 914, through which the computer system can receive instructions and data embodied in a carrier wave. When used in a local area networking (LAN) environment, the processing system 900 is connected (by wired connection or wirelessly) to a local network through the communication interface 924, which is one type of communications device. When used in a wide-area-networking (WAN) environment, the processing system 900 typically includes a modem, a network adapter, or any other type of communications device for establishing communications over the wide area network. In a networked environment, program modules depicted relative to the processing system 900 or portions thereof, may be stored in a remote memory storage device. It is appreciated that the network connections shown are examples of communications devices for and other means of establishing a communications link between the computers may be used.

In an example implementation, a storage controller, and other modules may be embodied by instructions stored in memory 908 and/or the storage unit 912 and executed by the processor 902. Further, the storage controller may be configured to assist in supporting the RAID0 implementation. A RAID storage may be implemented using a general-purpose computer and specialized software (such as a server executing service software), a special purpose computing system and specialized software (such as a mobile device or network appliance executing service software), or other computing configurations. In addition, keys, device information, identification, configurations, etc. may be stored in the memory 908 and/or the storage unit 912 and executed by the processor 902.

The processing system 900 may be implemented in a device, such as a user device, storage device, IoT device, a desktop, laptop, computing device. The processing system 900 may be a storage device that executes in a user device or external to a user device.

In addition to methods, the embodiments of the technology described herein can be implemented as logical steps in one or more computer systems. The logical operations of the present technology can be implemented (1) as a sequence of processor-implemented steps executing in one or more computer systems and/or (2) as interconnected machine or circuit modules within one or more computer systems. Implementation is a matter of choice, dependent on the performance requirements of the computer system implementing the technology. Accordingly, the logical operations of the technology described herein are referred to variously as operations, steps, objects, or modules. Furthermore, it should be understood that logical operations may be performed in any order, unless explicitly claimed otherwise or unless a specific order is inherently necessitated by the claim language.

Data storage and/or memory may be embodied by various types of processor-readable storage media, such as hard disc media, a storage array containing multiple storage devices, optical media, solid-state drive technology, ROM, RAM, and other technology. The operations may be implemented processor-executable instructions in firmware, software, hard-wired circuitry, gate array technology and other technologies, whether executed or assisted by a microprocessor, a microprocessor core, a microcontroller, special purpose circuitry, or other processing technologies. It should be understood that a write controller, a storage controller, data write circuitry, data read and recovery circuitry, a sorting module, and other functional modules of a data storage system may include or work in concert with a processor for processing processor-readable instructions for performing a system-implemented process

The embodiments of the disclosed technology described herein are implemented as logical steps in one or more computer systems. The logical operations of the presently disclosed technology are implemented (1) as a sequence of processor-implemented steps executing in one or more computer systems and (2) as interconnected machine or circuit modules within one or more computer systems. The implementation is a matter of choice, dependent on the performance requirements of the computer system implementing the disclosed technology. Accordingly, the logical operations making up the embodiments of the disclosed technology described herein are referred to variously as operations, steps, objects, or modules. Furthermore, it should be understood that logical operations may be performed in any order, adding and omitting as desired, unless explicitly claimed otherwise or a specific order is inherently necessitated by the claim language.

The above specification, examples, and data provide a complete description of the structure and use of exemplary embodiments of the disclosed technology. Since many embodiments of the disclosed technology can be made without departing from the spirit and scope of the disclosed technology, the disclosed technology resides in the claims hereinafter appended. Furthermore, structural features of the different embodiments may be combined in yet another embodiment without departing from the recited claims.

What is claimed is:

1. An apparatus comprising:
a storage media; and
a storage controller configured to:
divide physical storage space of the storage media into a plurality of media zones between an inner diameter (ID) and an outer diameter (OD) of the storage media, and
write LBA sectors to the media zones in a direction from the ID to the OD and to write the data in the direction from the OD to the ID within each media zone.

2. The apparatus of claim 1, wherein the storage media is a CMR HDD configured to operate in a reverse-seek mode in a RAID0 array.

3. The apparatus of claim 2, wherein the storage controller is further configured to map lower logical block address (LBA) zone of host data to media zones near the OD.

4. The apparatus of claim 2, wherein the storage controller is further configured to map higher logical block address (LBA) zone of host data to media zones near the ID.

5. The apparatus of claim 1, wherein the storage media is an SMR HDD configured to operate in a reverse-seek mode in a RAID0 array.

6. The apparatus of claim 5, wherein the controller is further configured to use media zones near the OD to store higher LBAs.

7. The apparatus of claim 5, wherein the controller is further configured to use media zones near the ID to store lower LBAs.

8. The apparatus of claim 5, wherein the storage controller is further configured to have the LBAs within a particular media zone follow the direction of shingles in that particular media zone.

9. A method comprising:
dividing physical storage space of a storage media into a plurality of media zones, wherein the media zones are aligned between an inner diameter (ID) and an outer diameter (OD) of the storage media; and
dividing the logical block address (LBA) space mapped to the storage area into a plurality of LBA sectors;
writing the LBA sectors to the media zones in a direction from the ID to the OD; and
within each media zone, writing the data in the direction from the OD to the ID.

10. The method of claim 8, wherein the storage media is a CMR HDD and the method further comprising operating the storage media is a reverse-seek mode.

11. The method of claim 10, wherein the CMR HDD is an even HDD in a RAID0 array and the method further comprising operating an odd HDD in the RAID0 array in forward-seek mode.

12. The method of claim 10, further comprising mapping lower logical block address (LBA) zone of host data to media zones near the OD.

13. The method of claim 10, further comprising mapping higher logical block address (LBA) zone of host data to media zones near the ID.

14. The method of claim 8, wherein the storage media is a SMR HDD and the method further comprising operating the storage media is a reverse-seek mode.

15. The method of claim 14, wherein the SMR HDD is an even HDD in a RAID0 array and the method further comprising operating an odd HDD in the RAID0 array in forward-seek mode.

16. A storage device controller configured to:
divide LBA address space mapped to a physical storage space into a plurality of LBA sectors;
divide physical storage space of the storage media into a plurality of media zones between an inner diameter (ID) and an outer diameter (OD) of the storage media, and
write LBA sectors to the media zones in a direction from the ID to the OD and to write the data within a given LBA sector in the direction from the OD to the ID within each media zone.

17. The storage device controller of claim 16, wherein the storage media is a CMR HDD configured to operate in a reverse-seek mode in a RAID0 array.

18. The storage device controller of claim 16, wherein the wherein the storage device controller is further configured to map lower logical block address (LBA) zone of host data to media zones near the OD.

19. The storage device controller of claim 16, wherein the wherein the storage device controller is further configured to map higher logical block address (LBA) zone of host data to media zones near the ID.

20. The storage device controller of claim 16, wherein the storage media is an SMR HDD configured to operate in a reverse-seek mode in a RAID0 array.

21. The storage device controller of claim 20, wherein the storage device controller is further configured to map lower LBA zone of host data to lower physical address of shingled media zones near a median diameter (MD).

22. The storage device controller of claim 20, wherein the storage device controller is further configured to map higher LBA zone of host data to higher physical address of shingled media zones near a median diameter (MD).
